(19) United States
(12) Patent Application Publication
(10) Pub. No.: US 2007/0048571 A1
(43) Pub. Date: Mar. 1, 2007

(54) Fuel cell system

(76) Inventors: Hironori Sasaki, Hitachi (JP); Kenji Yamaga, Hitachi (JP); Kiyoshi Hiyama, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/354,875

(22) Filed: Feb. 16, 2006

(30) Foreign Application Priority Data
Sep. 1, 2005 (JP) 2005-252957

(51) Int. Cl. H01M 8/04

(52) U.S. Cl. 429/25; 429/34; 429/23; 429/24

(57) ABSTRACT

The present invention is to offer a fuel cell system that efficiently removes the moisture contained in the anode offgas with the aid of a gas-liquid separator, which is installed in the circulation line of fuel gas, by sensing the pressure of the anode offgas led into the gas-liquid separator and that of the dry gas for absorbing the contained moisture and controlling the pressures within a suitable range. The fuel cell system of the present invention is provided with a fuel cell, comprising an anode to be supplied fuel gas, a cathode to be supplied oxidizing gas, a gas circulating line for supplying the anode offgas exhausted from the anode to the anode; and a gas-liquid separator for removing the moisture contained in the anode offgas installed in the gas circulating line; and provided with each gas pressure sensor for sensing the pressure of the anode offgas supplied to the gas-liquid separator and the pressure of the dry gas for absorbing the moisture contained in the anode offgas supplied to the gas-liquid separator.

### CLAIM OF PRIORITY

The present application claims priority from Japanese application serial No. 2005-252957, filed on Sep. 1, 2005, the contents of which is hereby incorporated by references into this application.

### BACKGROUND OF THE INVENTION

1. Field of the Invention

The present invention relates to a fuel cell system equipped with a fuel cell that generates electric energy through chemical reaction between hydrogen and oxygen.

2. Description of Related Art

Fuel cell generates electricity by supplying fuel gas to anode and oxidizing gas to cathode.

There has been a fuel cell system using the above fuel cell in which the anode offgas exhausted from the anode of the fuel cell is circulated and supplied as the fuel gas to the anode in order to efficiently utilize the fuel gas.

The Patent Document 1 discloses a fuel cell system in which a gas-liquid separator is installed in a fuel gas circulating line so as to separate the moisture from the anode offgas.

[Patent Document 1] Japanese Application Patent Laid-Open Publication No. 2003-157873

### SUMMARY OF THE INVENTION

When a gas-liquid separator is installed in the fuel gas circulating line so as to efficiently remove the moisture from the anode offgas exhausted from the anode, it is important to sense the pressure of the anode offgas led into the gas-liquid separator and that of the dry gas for absorbing the moisture contained in the anode offgas led into the gas-liquid separator. It is very essential to control these pressures to be within a suitable range.

Accordingly, the present invention offers a fuel cell system that employs a gas-liquid separator to efficiently remove the moisture contained in the anode offgas exhausted from the anode of a fuel cell.

The fuel cell system of the present invention is provided with a fuel cell, comprising an anode to which fuel gas is supplied and a cathode to which oxidizing gas is supplied, a gas circulating line for supplying the anode offgas exhausted from the anode to the anode, and a gas-liquid separator, installed in the gas circulating line, for removing the moisture contained in the anode offgas; and also provided with each gas pressure sensor for sensing the pressure of the anode offgas supplied to the gas-liquid separator and the pressure of the dry gas for absorbing the moisture contained in the anode offgas supplied to the gas-liquid separator.

The present invention, using a gas-liquid separator, enables to efficiently remove the moisture contained in the anode offgas exhausted from the anode of a fuel cell.

### BRIEF DESCRIPTION OF THE DRAWINGS

FIG. 1 is a block diagram of the construction of the fuel cell system as the first embodiment to be applied the present invention.

FIG. 2 is a block diagram of the construction of the fuel cell system as the second embodiment to be applied the present invention.

FIG. 3 is a block diagram of the construction of the fuel cell system as the third embodiment to be applied the present invention.

### DETAILED DESCRIPTION OF THE INVENTION

Preferred embodiments of the present invention are described hereunder.

The fuel cell system of this embodiment is equipped with a fuel cell that generates electricity by supplying hydrogen-contained fuel gas to the anode as fuel electrode and oxygen-contained oxidizing gas to the cathode as air electrode, a gas circulating line that supplies the anode offgas containing unconverted gas exhausted from the anode back to the anode, and a gas-liquid separator that is installed in the gas circulating line and removes the moisture from the anode offgas.

It is preferred that the gas-liquid separator is a water-transmission membrane type.

It is important to control the pressure of the anode offgas supplied to the gas-liquid separator and that of the dry gas for absorbing the moisture contained in the anode offgas. They are controlled based on the gas pressure sensor installed in the piping of each gas led into the gas-liquid separator.

It is preferred that the system is provided with a pressure regulator that controls the pressure of the anode offgas supplied to the gas-liquid separator and a pressure regulator that controls the pressure of the dry gas for absorbing the moisture contained in the anode offgas supplied to the gas-liquid separator and that each pressure regulator is controlled based on the signal of each gas pressure sensor.

In addition, it is preferred that the gas-liquid separator is such that consists of two cylindrical moving phases put together concentrically. It is also preferred that the anode offgas is made flow inside and the dry gas is made flow outside the gas-liquid separating membrane set in the gas-liquid separator.

It is then preferred that the dew-point temperature of the dry gas is lower than that of the anode offgas.

It is additionally preferred that the anode offgas and dry gas are made flow in the opposite direction to each other.

In a system like the above, it is permissible to provide a cell voltage sensor for sensing the voltage of the cell constituting the fuel cell and control the pressure of the dry gas based on the output of the cell voltage sensor and to provide a temperature sensor for sensing the temperature of the fuel cell and control the pressure of the dry gas based on the output of the temperature sensor.

Dry gas may be supplied from a separate air blower. When supplying dry gas from the air blower to the gas-liquid separator, it is possible to provide a bypass line branched from the dry gas supply line from the air blower to the gas-liquid separator and a regulating valve can be installed in the bypass line for controlling the flowrate of the dry gas. Thus, the supply volume of dry gas to the gas-liquid separator can be controlled. By controlling the supply volume of the dry gas like the above, the amount of moisture to be removed, that is, the moisture content of the anode offgas can be controlled. Accordingly, it becomes possible to supply the fuel gas at a suitable dew-point temperature.

It is possible to utilize the cathode offgas exhausted from the cathode as the dry gas and supply it to the gas-liquid separator. In doing this, it is preferred to perform a process to enrich the nitrogen density of the cathode offgas.

The fuel cell system of this embodiment is equipped with a fuel cell that comprises an anode to which the fuel gas is supplied and a cathode to which the oxidizing gas is supplied, a gas circulating line that supplies the anode offgas exhausted from the anode back to the anode, a gas-liquid separator that is installed in the gas circulating line and removes the moisture from the anode offgas, and an exhaust valve that exhausts the anode offgas into the air.

When exhausting the anode offgas from the exhaust valve in a system like the above, it is preferred to dilute it with the cathode offgas exhausted from the cathode. It is preferred that the exhaust valve be installed in the gas circulating line or in a line branched from the gas circulating line.

In case of supplying dry gas directly from an air blower, it is possible to utilize the dry gas, led into the gas-liquid separator and then exhausted from it, as the oxidizing gas.

While the oxidizing gas supplied to the air electrode means the air, it is permissible to vary the hydrogen density of the air.

The gas-liquid separator is so constructed that a gas with higher dew-point temperature and gas with lower dew-point temperature flow facing each other with a water-transmission membrane between them and that the moisture contained in the gas with higher dew-point temperature transmits through the water-transmission membrane and is absorbed by the gas with lower dew-point temperature flowing on the opposite side of the water-transmission membrane.

The gas-liquid separator is formed in a concentric construction of two moving phases facing each other and the two moving phases are directed oppositely. By letting two gases of greatly different dew-point temperatures flow on both sides of the water-transmission membrane and also by setting the pressure of the dry gas supplied to the gas-liquid separator greater than that of the anode offgas, moisture can be removed more efficiently.

The water-transmission membrane used for the gas-liquid separator employs solid polymer membrane with high gas barrier characteristic and high water transmission, and it is preferred to employ fluorine high-polymer membrane used as the electrolyte membrane of fuel cell. The gas barrier characteristic means a characteristic of preventing the mixture of the hydrogen gas with dry gas through the gas-liquid separating membrane, that is, a characteristic of preventing gas transmission. The water transmission means a characteristic of allowing moisture to transmit.

By forming the gas-liquid separating membrane used in the gas-liquid separator into a hollow shape, for example, the pressure loss can be reduced. When hollow membrane fibers are utilized, the anode offgas flows inside the hollow fiber and the moisture is selectively removed through the hollow membrane fiber in the course of flow.

When the cell voltage sensor for sensing the cell voltage is installed, and if the cell voltage becomes off the specified range, the moisture standing in the gas circulating line can be efficiently removed by controlling the pressure of the dry gas supplied to the gas-liquid separator.

For example, abnormal voltage of the cell may be caused by a phenomenon of flatting wherein the moisture stands in a line. This cause can be eliminated by so controlling as to increase the pressure difference between the dry gas and anode offgas.

When the temperature sensor for sensing the fuel cell temperature is installed, it becomes possible to decrease the pressure difference between the dry gas and anode offgas in case the fuel cell temperature is higher and increase the pressure difference between the dry gas and anode offgas in case the fuel cell temperature is lower. Thus, the pressure difference between the dry gas and anode offgas can be controlled in accordance with the fuel cell temperature so as to control the moisture contained in the anode offgas.

In addition, when the temperature sensor for sensing the fuel cell temperature is installed, it becomes possible to increase the dry gas pressure in case the fuel cell temperature is higher and decrease the dry gas pressure in case the fuel cell temperature is lower. Thus, the dry gas pressure can be controlled in accordance with the fuel cell temperature so as to control the moisture contained in the anode offgas.

If an outside temperature sensor is provided outside the system, it becomes possible to control the dry gas pressure taking the fuel cell temperature and outside temperature into account, thereby enabling to efficiently control the moisture standing in the gas circulation line.

In addition, it is preferred to provide a fuel gas pressure sensor for sensing the pressure of the fuel gas supplied to the anode, by which the on/off timing of the regulating valve for controlling the fuel gas pressure can be so controlled that the fuel gas pressure sensed by the fuel gas pressure sensor falls within a specified range. Thus, the fuel gas can be supplied to constant and stability is increased.

Although the above description refers to pressure control, it is permissible to control the flowrate along with the pressure.

It is possible that the dew-point temperature of the fuel gas supplied to the anode is set to 0-10° C. and that of the oxidizing gas supplied to the cathode is set to 30-50° C. With this setting, the moisture content in the fuel gas is kept low and hence more stable fuel cell system can be designed.

By supplying the cathode offgas exhausted from the cathode to the gas-liquid separator as the dry gas, the moisture contained in the anode offgas can also be removed and consequently only a single supply can serve as both the oxidizing gas supply and dry gas supply.

The moisture absorption process may be conducted before the cathode offgas is led into the gas-liquid separator.

The dry gas led into the gas-liquid-separator and used for the moisture absorption of the anode offgas can be utilized as the oxidizing gas and consequently only a single supply can serve as both the oxidizing gas supply and dry gas supply.

By performing a process for enriching the nitrogen density of the cathode offgas and supplying it to the gas-liquid separator as the dry gas, the moisture contained in the anode offgas can also be removed. The process for enriching the nitrogen density means a process for increasing the nitrogen density up to 95-99% by using a membrane through which the oxygen in the air transmits more easily than the nitrogen, that is, a process for generating nitrogen-enriched gas.

In addition, an exhaust valve for exhausting the anode offgas into the air may be installed on a line branched from the line between the anode exhaust side and gas-liquid separator. In exhausting the anode offgas into the air through the exhaust valve, it is possible to control the density of the anode offgas to an allowable exhaust level by using the nitrogen-enriched gas.

The fuel cell system like the above enables to offer a system that can efficiently remove the moisture contained in the anode offgas exhausted from the anode of the fuel cell and yet is compact in size.

Concrete embodiments are described hereunder, using figures.

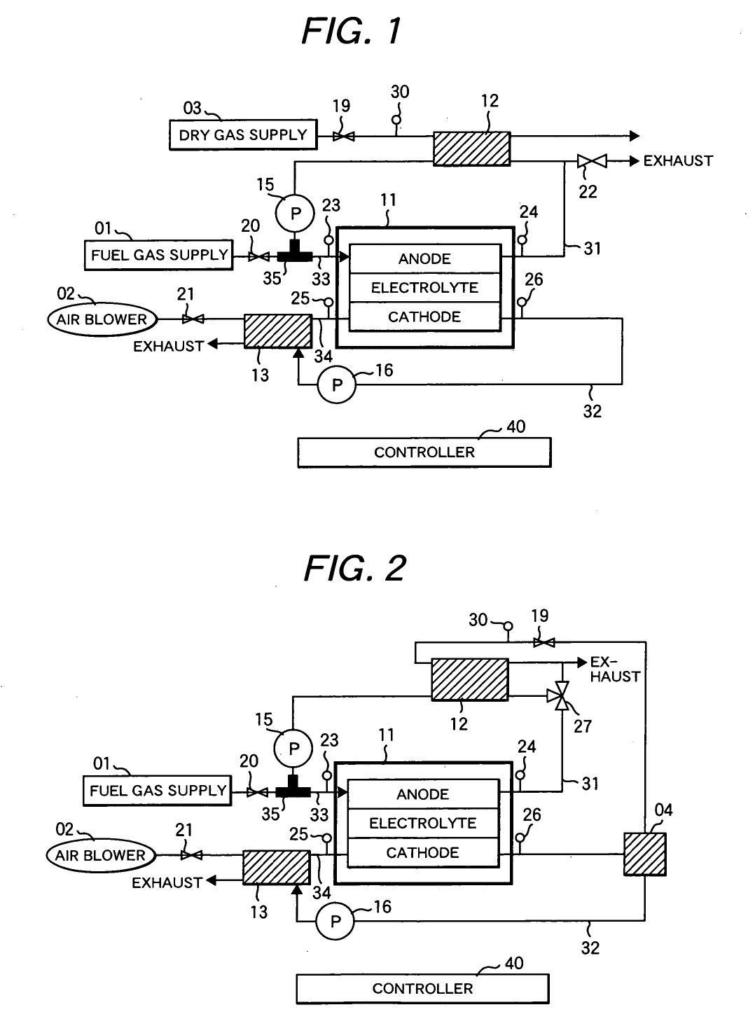

FIG. 1 shows an overall construction of the fuel cell system according to the first embodiment.

As shown in FIG. 1, the fuel cell system of this embodiment is equipped with a fuel cell 11.

The fuel cell 11 is constructed as a fuel cell stack made from layered multiple unit cells, in which a solid polymer electrolytic membrane is placed as electrolyte, and an anode as fuel electrode and a cathode as air electrode are formed on both sides, and then they are sandwiched by separators.

The fuel cell 11 generates electricity from the following electrochemical reactions while hydrogen-contained fuel gas is supplied to the anode from a fuel cell supply 01 and oxygen-contained oxidizing gas is supplied to the cathode from an air blower 02.
H₂→2H⁺+2e⁻ (1)
(½)O₂+2H³⁰ +2e⁻→H₂O (2)
H₂+(½)O₂→H₂O (3)

The formula (1) is a reaction on the anode and formula (2) is a reaction on the cathode. In total, the reaction in the formula (3) develops. The water generated on the cathode is called generated water.

In this fuel cell system, the fuel gas containing hydrogen is supplied from the fuel gas supply 01 to the anode via a fuel gas pressure regulating valve 20 (hereinafter called the regulating valve 20) made of an electromagnetic valve, hydrogen pressure sensor 23 and hydrogen supply line 33.

In this description, the regulating valve 20 as a pressure regulating means is a valve for regulating the supply volume of the fuel gas; the hydrogen pressure sensor 23 is a sensor, installed just before the fuel gas is led into the fuel cell 11, for measuring the pressure of the hydrogen gas as fuel gas; and the hydrogen gas supply line 33 is a line for supplying the fuel gas to the anode.

The anode offgas exhausted from the anode containing unconverted gas is led through a hydrogen gas circulating line 31, where the moisture contained in the anode offgas is removed by the gas-liquid separator installed on the hydrogen gas circulating line, and supplied to a connector 35 at a specified pressure by a pump 15, and then mixed with fresh fuel gas and supplied back to the anode.

The gas-liquid separator 12, containing a water-transmission membrane, is a device in which the anode offgas and dry gas are made flow in the opposite direction to each other on both sides of the water-transmission membrane. Dry gas is the gas supplied from a dry gas supply 03.

The water-transmission membrane is a solid polymer membrane with high gas barrier characteristic and high water transmission. Any water-transmission membrane is applicable so far as it has high gas barrier characteristic and high water transmission. By using a water-transmission membrane like the above, the anode offgas would not mix into the dry gas flowing on the other side of the membrane but still the moisture contained in the anode offgas can be removed and discharged out of the line.

By forming the water-transmission membrane into a shape of hollow fiber, the pressure loss can be decreased. Then, while the anode offgas flows inside the hollow membrane fiber, the moisture is selectively removed through the hollow membrane fiber in the course of flow.

A controller 40 consists of a microcomputer comprising CPU, ROM and RAM and other peripheral devices. The controller 40 reads the difference between a hydrogen pressure sensor 23 for measuring the pressure at the anode inlet and hydrogen pressure sensor 24 for measuring the pressure at the anode outlet, that is, the pressure loss of the anode, and controls the opening of the regulating valve 20.

The controller 40 also reads the difference between an oxidizing gas pressure sensor 25 for measuring the pressure at the cathode inlet and oxidizing gas pressure sensor 26 for measuring the pressure at the cathode outlet, that is, the pressure loss of the cathode, and controls the opening of the regulating valve 20 and hydrogen gas pressure regulating valve 21, functioning as an electro-magnetic valve, so that the difference between the reading and the pressure loss of the anode falls within an allowable range of 3 to 17 kPa. The oxidizing gas pressure regulating valve 21 is a valve for regulating the pressure of the oxidizing gas.

The controller 40 controls a dry gas pressure regulating valve 19, a means for regulating the dry gas pressure, and regulating valve 20 based on the signals of the cell voltage and temperature of the fuel cell 11 and also on the signals from a dry gas pressure sensor 30, a means for sensing the pressure of the dry gas led into the gas-liquid separator 12, and hydrogen pressure sensor 24.

If, for example, the temperature of the fuel cell 11 is higher than a normal operating condition, the moisture in the fuel cell is likely to be insufficient. On this occasion, the dry gas pressure regulating valve 19 can be controlled to increase the dry gas pressure so as to reduce the absorption of the moisture contained in the anode offgas. The regulating valve 20 can also be controlled to decrease the fuel gas pressure so as to prevent the electrolytic membrane of the fuel cell from drying up.

If, for example, the voltage of the fuel cell 11 drops, it is assumed that the moisture in the fuel cell becomes excessive. On this occasion, the dry gas pressure regulating valve 19 can be controlled to decrease the dry gas pressure or the regulating valve 20 can be controlled to increase the anode offgas pressure so as to remove the moisture contained in the anode offgas.

In addition, where the system is equipped with a temperature sensor (not shown) as a means for sensing the temperature of the fuel cell 11 and also with an outside temperature sensor (not shown) as a means for sensing the outside temperature, if the temperature of the fuel cell 11 is higher, the pressure difference between the dry gas and anode offgas can be reduced and, if the temperature of the fuel cell is lower, the pressure difference between the dry gas and anode offgas can be increased. Thus, the pressure difference between the dry gas and anode offgas can be controlled in accordance with the temperature of the fuel cell so as to control the moisture contained in the anode offgas.

In FIG. 1, an exhaust valve 22 installed on a line branched from the hydrogen gas circulating line 31 will not operate during the operation except in case of emergency, but it is turned on and off upon startup and shutdown of the system for the purpose of purging. The exhaust valve 22 may be installed on the hydrogen gas circulating line 31.

The oxidizing gas supplied from the air blower 02 is supplied to the cathode via the oxidizing gas pressure regulating valve 21, oxidizing gas pressure sensor 25 and oxidizing gas supply line 34. The cathode offgas exhausted from the cathode in the above flow contains generated water. The cathode offgas containing generated water is supplied to a humidifier 13 via the oxidizing gas circulating line 32 and pump 16 and utilized there to humidify the oxidizing gas supplied from the air blower 02.

The oxidizing gas supply line 34 is a line for supplying the oxidizing gas to the cathode. The oxidizing gas circulating line 32 is a line for supplying the cathode offgas exhausted from the cathode to the humidifier 13. The humidifier 13 is a device for humidifying the oxidizing gas by utilizing the cathode offgas containing generated water. Humidifying the oxidizing gas can prevent the electrolyte from drying up.

The humidifier 13 humidifies the oxidizing gas through a similar process as in the gas-liquid separator 12. That is, by making the cathode offgas containing generated water and oxidizing gas flow in the opposite direction to each other on both sides of the water-transmission membrane, the moisture contained in the cathode offgas transmits through the water-transmission membrane and is absorbed by the oxidizing gas with lower dew-point temperature flowing on the other side of the water-transmission membrane.

The water-transmission membrane used in the humidifier 13 is almost similar to that in the gas-liquid separator 12 but it is a solid polymer membrane with particularly high water transmission, and fluorine high-polymer membrane used as the electrolyte membrane of the fuel cell 11 is employed. Differently from the one used in the gas-liquid separator 12, however, gas barrier characteristic is not so much important and accordingly any type of water-transmission membrane is applicable so far as it exhibits high water transmission.

The dry gas supply 03 for supplying gas to the gas-liquid separator 12 in FIG. 1 can be any, including an inert gas cylinder or small air blower that has been provided for purging purpose, so far as the dew-point temperature of the gas is lower than that of the anode offgas.

In consideration of a smaller, lighter and less costly system, however, using the exhaust gas that has been humidified by the humidifier 13 as the dry gas enables to design the system more compact and also to realize lower cost because neither cylinder replacement nor power source is necessary.

In FIG. 1, the moisture contained in the anode offgas is removed by letting the anode offgas inside and dry gas having lower dew-point temperature than the anode offgas outside the gas-liquid separating membrane of the gas-liquid separator 12 consisting of two cylindrical moving phases put together concentrically.

By so designing the flow path that the dry gas flows in the opposite direction to that of the anode offgas flowing on the other side of the water-transmission membrane, that is, in the direction opposed at 180°, unevenness in water collecting area can be prevented and hence the moisture can be discharged more efficiently.

According to the first embodiment, where the exhaust of the cathode offgas used for the humidification by the humidifier 13 is utilized as the dry gas to be supplied to the gas-liquid separator 12, the dew-point temperature of the anode offgas can be lowered to 30° C. which is about 40° C. if the gas-liquid separator 12 is not employed.

By installing the gas-liquid separator 12, the moisture contained in the anode offgas can be discharged more efficiently as explained above, and accordingly a problem that the moisture contained in the anode offgas blocks the gas line, resulting in drastically deteriorated generating efficiency has been solved and stable as well as efficient power generation becomes possible.

In addition, since a water reservoir for keeping the removed moisture is not needed and also a separate air blower for dry gas supply needs not be installed, this system contributes to realize a compact and light design.

By installing the gas-liquid separator 12 like the above-mentioned, the moisture is removed from time to time and consequently exhausting the moisture into the air by using the fuel gas becomes no longer necessary during the power generation of the fuel cell system, thereby enabling stable power generation.

Since the fuel gas needs not be employed to exhaust the moisture in a system like the above, the fuel usage ratio is not be deteriorated greatly and so a suitable fuel cell system can be offered particularly where the system is equipped with a limited fuel storage means such as cylinder.

### Second Embodiment

FIG. 2 shows an overall construction of the fuel cell system according to the second embodiment of the present invention.

The fuel cell system in FIG. 2 is a system in which a nitrogen enricher 04 is installed on the cathode offgas line of the first embodiment for the offgas exhausted from the cathode.

In FIG. 2, the nitrogen enricher 04 is a device making the use of a characteristic of a hollow membrane fiber made for example of polyimide that oxygen transmits through it more easily than nitrogen, in which oxygen transmits through the hollow membrane fiber selectively while the cathode offgas flows inside the membrane fiber, and consequently nitrogen-enriched gas having the nitrogen content of more than 90% is obtained at the outlet of the hollow membrane fiber. Using the nitrogen enricher 04 enables to supply the nitrogen-enriched gas having much lower dew-point temperature to the gas-liquid separator 12 as the dry gas.

There is no specific limitation to the shape and material of the nitrogen enricher 04 and any will do. However, since more compact fuel cell system is required these days, it is preferable to use a nitrogen enricher 04 of a module design made of a bundle of nitrogen separating hollow membrane fibers. Since the dew-point temperature of the nitrogen-enriched gas of the above design can be lowered down to −40° C., the dew-point temperature of the anode offgas after the gas-liquid separation process can be about 5° C. in case the dew-point temperature of the anode offgas is 40° C.

The anode offgas that has been enriched with nitrogen by the nitrogen enricher 04 is led into the gas-liquid separator 12 to serve as the dry gas and the other gas is led into the humidifier 13.

In FIG. 2, the operation of a three-way regulating valve 27 can be controlled by the controller 40. In exhausting the hydrogen gas into the air, the valve opening is adjusted so as to control the hydrogen density to an allowable exhaust level by using the nitrogen-enriched gas. Accordingly, unconverted fuel gas can be exhausted more safely.

In addition, as described in the first embodiment, the controller 40 controls the dry gas pressure regulating valve 19 for controlling the dry gas pressure and regulating valve 20 based on the cell voltage and temperature signals of the fuel cell 11 and also on the signals of the dry gas pressure sensor 30 for sensing the pressure of the dry gas led into the gas-liquid separator 12 and hydrogen pressure sensor 24.

### Third Embodiment

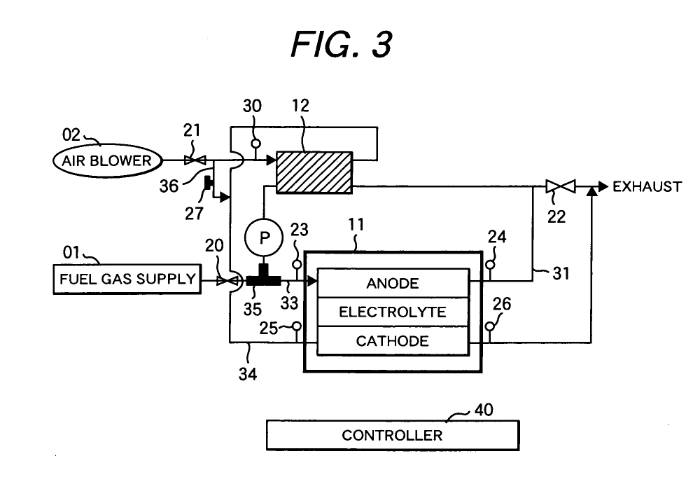

FIG. 3 shows an overall construction of the fuel cell system according to the third embodiment of the present invention.

In FIG. 3, the gas-liquid separator 12 functions as the gas-liquid separator 12 and humidifier 13 as well in FIG. 1. Integrating two devices into one can contribute to realize small and light system. Accordingly, the dry gas can be utilized as the oxidizing gas and so a single air blower can serve as both dry gas supply and oxidizing gas supply.

In addition, since the atmospheric air is utilized as the dry gas, the dew-point temperature of the dry gas is around 10° C. Accordingly, in case the dew-point temperature of the anode offgas is about 40° C., the dew-point temperature of the anode offgas after the gas-liquid separation process can be lowered down to about 15° C.

By supplying the anode offgas to the gas-liquid separator 12 and removing the moisture from it, the dew-point temperature of the fuel gas supplied to the anode including unconverted fuel gas can be lowered to 0 to 10° C. and fuel gas with containing less moisture can be supplied.

On the other hand, by allowing the dew-point temperature of the oxidizing gas supplied to the cathode to be 30 to 50° C., moisture shortage on the anode side can be filled up from the cathode side, maintaining the humidification balance. Accordingly, the electrolytic membrane can be prevented from drying up and a stable fuel cell system can be offered.

The controller 40 reads the difference between the hydrogen pressure sensor 23 for measuring the pressure at the anode inlet and hydrogen pressure sensor 24 for measuring the pressure at the anode outlet, that is, the pressure loss of the anode, and controls the opening of the regulating valve 20. The controller 40 also reads the difference between the oxidizing gas pressure sensor 25 for measuring the pressure at the cathode inlet and oxidizing gas pressure sensor 26 for measuring the pressure at the cathode outlet, that is, the pressure loss of the cathode, and controls the opening of the regulating valve 20 and hydrogen gas (dry gas) pressure regulating valve 21 so that the difference between the reading and the pressure loss of the anode falls within an allowable range of 3 to 17 kPa. The oxidizing gas (dry gas) pressure regulating valve 21 is a valve for regulating the pressure of the dry gas that also functions as the oxidizing gas.

In addition, the controller 40 can control the oxidizing gas (dry gas) pressure regulating valve 21 and regulating valve 20 so as to control the dry gas pressure and hydrogen gas pressure sensed by the dry gas pressure sensor 30 and hydrogen pressure sensor 24 in accordance with the cell voltage of the fuel cell 11, temperature of the fuel cell 11 and outside temperature of the fuel cell system.

For example, if the fuel cell is hot, the dry gas pressure is increased or fuel cell pressure is decreased to control the moisture absorption. Thus, the electrolytic membrane of the fuel cell can be prevented from drying up.

In addition, by installing a bypass line 36 branched from the supply line from the air blower to the gas-liquid separator 12 and a regulating valve 27, the volume of the dry gas supplied to the gas-liquid separator 12 can be controlled.

Accordingly, the moisture to be removed from the anode offgas can be controlled appropriately and so a more stable fuel cell system can be offered. It becomes possible to supply the fuel gas at a suitable dew-point temperature to the fuel cell through a control in which, for example, the dew-point temperature is set higher in the beginning of generation and, if water stays in the system and the signal from the hydrogen gas pressure sensor 23 indicates pressure increase during the operation, the regulating valve 20 is set closer.

It also becomes possible to install a humidifier on the oxidizing gas supply line 34 so as to humidify the oxidizing gas supplied to the cathode by using moisture-contained cathode offgas exhausted from the cathode.

What is claimed:

1. A fuel cell system provided with a fuel cell, comprising an anode to be supplied fuel gas, a cathode to be supplied oxidizing gas, a gas circulating line for supplying anode offgas exhausted from the anode to the anode, and a gas-liquid separator for removing the moisture contained in the anode offgas installed in the gas circulating line,
further comprising,
each of gas pressure sensor for sensing the pressure of the anode offgas supplied to the gas-liquid separator and the pressure of the dry gas for absorbing the moisture contained in the anode offgas supplied to the gas-liquid separator, respectively.

2. A fuel cell system according to claim 1,
further comprising,
a pressure regulator to control the pressure of the anode offgas supplied to the gas-liquid separator, and a pressure regulator to control the pressure of the dry gas for absorbing the moisture contained in the anode offgas supplied to the gas-liquid separator, and each of the pressure regulator is controlled based on the signal of the each gas pressure sensor.

3. A fuel cell system according to claim 1,
wherein,
the gas-liquid separator is a water-transmission membrane type gas-liquid separator consisting of multiple moving phases, a bundle of hollow membrane fibers.

4. A fuel cell system according to claim 1,
wherein,
the dew-point temperature of the dry gas is lower than that of the anode offgas.

5. A fuel cell system according to claim 3,
wherein,
the anode offgas is made flow inside and the dry gas is made flow outside the gas-liquid separating membrane set in the water-transmission membrane type gas-liquid separator.

6. A fuel cell system according to claim 5,
wherein,
the anode offgas and dry gas are made flow in the opposite direction to each other.

7. A fuel cell system according to claim 1,
further comprising,
a cell voltage sensor for sensing the voltage of the cell constituting the fuel cell, and the pressure of the dry gas is controlled based on the output of the cell voltage sensor.

8. A fuel cell system according to claim 1,
further comprising,
a temperature sensor for sensing the temperature of the fuel cell, and the pressure of the dry gas is controlled based on the output of the temperature sensor.

9. A fuel cell system according to claim 1,
further comprising;
a regulating valve for controlling the fuel gas pressure and a fuel gas pressure sensor for sensing the pressure of the fuel gas supplied to the anode, and the on/off timing of the regulating valve is so controlled that the fuel gas pressure sensed by the fuel gas pressure sensor falls within a specified range.

10. A fuel cell system according to claim 9,
further comprising;
a cell voltage sensor for sensing the voltage of the cell constituting the fuel cell, and the pressure of the dry gas is controlled based on the output of the cell voltage sensor.

11. A fuel cell system according to claim 9,
further comprising;
a temperature sensor for sensing the temperature of the fuel cell, and the pressure of the dry gas is controlled based on the output of the temperature sensor.

12. A fuel cell system according to claim 1,
wherein,
the dew-point temperature of the fuel gas supplied to the anode is set to 0 to 10° C. and that of the oxidizing gas supplied to the cathode is set to 30 to 50° C.

13. A fuel cell system according to claim 1,
wherein,
the dry gas is supplied from an air blower.

14. A fuel cell system according to claim 1,
wherein,
the cathode offgas exhausted from the cathode is utilized as the dry gas to be supplied to the gas-liquid separator.

15. A fuel cell system according to claim 14,
further comprising;
a nitrogen enricher that processes to enrich the nitrogen density of the cathode offgas.

16. A fuel cell system provided with a fuel cell, comprising,
an anode to be supplied fuel gas, a cathode to be supplied oxidizing gas, a gas circulating line for supplying the anode offgas exhausted from the anode to the anode, a gas-liquid separator for removing the moisture contained in the anode offgas installed in the gas circulating line, and an exhaust valve for exhausting the anode offgas into the air installed either in the gas circulating line or in a line bypassed from the gas circulating line,
wherein,
the cathode offgas exhausted from the cathode is mixed with the anode offgas at the time of exhausting the anode offgas from the exhaust valve.

17. A fuel cell system according to claim 16,
wherein,
the cathode offgas is performed a process for enriching the nitrogen density thereof which is utilized to exhaust the anode offgas.

18. A fuel cell system according to claim 1,
wherein,
the offgas led into the gas-liquid separator is utilized as the oxidizing gas.

19. A fuel cell system according to claim 13,
further comprising;
a bypass line branched from the dry gas supply line from the air blower to the gas-liquid separator.

20. A fuel cell system according to claim 19,
further comprising;
a regulating valve for controlling the flowrate of the dry gas in the bypass line.
